(19) United States
(12) Patent Application Publication
(10) Pub. No.: US 2012/0086314 A1
(43) Pub. Date: Apr. 12, 2012

(54) ELECTRONICALLY CONTROLLED SECURITY CABINET

(75) Inventors: Brian Patrick Bourke, Jefferson, WI (US); Eric James Wipperfurth, Fort Atkinson, WI (US)

(73) Assignee: SPACESAVER CORPORATION, Fort Atkinson, WI (US)

(21) Appl. No.: 13/270,361

(22) Filed: Oct. 11, 2011

Related U.S. Application Data
(60) Provisional application No. 61/392,099, filed on Oct. 12, 2010.

(51) Int. Cl. G06F 7/04; A47B 47/00; A47B 87/00

(52) U.S. Cl. 312/109; 340/5.7; 340/5.54

(57) ABSTRACT

An electronic evidence locker having a series of individual storage lockers controlled by an electronic control unit. The electronic control unit receives identification information from a potential user and determines the level of access for the user. Based upon the access assigned to the user, the control unit allows the user to deposit or remove evidence from individual lockers. The control unit maintains a complete audit log of all activity by the user as well as all activity with respect to depositing and removing evidence from the individual storage lockers.

### CROSS-REFERENCE TO RELATED APPLICATION

The present application is based on and claims priority to U.S. Provisional Patent Application Ser. No. 61/392,099 filed on Oct. 12, 2010, the disclosure of which is incorporated herein by reference.

### BACKGROUND OF THE INVENTION

The present disclosure generally relates to a series of electronically controlled security lockers. More specifically, the present disclosure relates to a system and method that controls access to each of a plurality of individual security lockers and generates an electronic audit log to track the access to each of the lockers.

Presently, various different markets have a need for a security locker system that controls the access to each of a series of individual storage lockers. As one example, in a police setting, it is desirable to have a series of individual storage lockers that can be accessed by only authorized personnel such that valuable items or evidence can be stored in the individual lockers. In such systems, access is provided to each of the individual lockers by either an access code or scanning a personal identification card into a control system for the individual lockers. Based upon the identity of the person accessing the system, the control unit of the locker system allows access to one or more of the individual lockers for the authorized personnel to either place items into the locker or remove items from the locker. Although such access systems are currently available, such as the ACCESS 500 system available from Spacesaver Corporation of Fort Atkinson, Wis., it is further desirable to provide a clear accounting of who accessed the lockers and when such access was granted.

Although such system is useful in monitoring the access to evidence, similar type systems for controlling access to individual storage lockers is also useful in other types of markets, such as the healthcare market, apartment and housing complexes, retail establishments and any other type of location in which it is desirable to provide electronic access to individual storage lockers and monitor the access to each of the lockers as desired.

### SUMMARY OF THE INVENTION

The present disclosure relates to a security cabinet that has a series of individual security lockers that can be used to store various different types of items, such as evidence in a law enforcement setting. The security cabinet of the present disclosure includes a control unit that monitors and controls access to each of the individual storage lockers and generates an audit trail to provide a detailed log of all of the access granted to each of the individual storage lockers.

The security cabinet of the present disclosure includes a series of individual storage lockers that each include an internal storage space and a locker door. The locker door can be selectively locked and unlocked through a door lock actuator. In addition to the door lock actuator, each of the storage lockers includes a door switch that provides an indication of when the locker door is opened and closed.

The security cabinet includes a control unit that is connected to the door lock actuator for each of the individual storage lockers. Additionally, the control unit is connected to each of the door switches of the storage lockers. In this manner, the control unit can monitor the opening and closing of each locker door and can control the locking and unlocking of each locker door through the associated door lock actuator.

During use of the security cabinet, the control unit receives user identification information from a user. The user identification information can be received through a card reader, a keypad or a combination of the card reader and keypad.

Once the control unit receives the required identification information from a user, the control unit then receives a locker access request from the user. The locker access request may include a request to deposit evidence or a request to remove evidence. After receiving the locker access request, the control unit determines the access rights of the identified user and the control unit will grant the locker access request from the user based upon the determined access rights.

In one embodiment of the disclosure, the control unit provides an indication to the user of the current status of each storage locker that meets the initial locker access request from the user. As an example, if the user indicates a desire to deposit evidence into one of the storage lockers, the control unit indicates to the user each of the lockers that is available for deposit. Likewise, if the user wishes to remove evidence from one of the storage lockers, the control unit indicates to the user which of the storage lockers includes evidence that can be removed by the specific user.

Once the control unit determines that the user has the proper access rights, the control unit unlocks a user-selected storage locker and monitors for the opening and closing of the locker door. Once the locker door has been opened and subsequently closed, the control unit creates an audit log entry for the action that just occurred for the storage locker. Typically, the audit log entry will include identification information for the user, identification information for the storage locker, and the type of action carried out by the user, such as depositing or removing evidence from the identified storage locker. The individual audit log entry is stored in a memory location and forms part of a complete audit log for the security cabinet.

The security cabinet further includes a memory access port that is coupled to the control unit. The memory access port allows the audit log to be downloaded from the memory of the control unit by a user. Once the audit log has been downloaded from the memory, the memory can be cleared and the audit log can be accessed and stored at another location.

Each individual user of the security cabinet is assigned an identification number and access rights. The assignment of the identification number and access rights can be done through a combination of a keypad formed as part of the security cabinet and a personal computer not associated with the security cabinet. After the access rights and identification number for each user are set in a personal computer, the information is downloaded to a data storage device. The data storage device interfaces with the control unit through the memory access port such that the listing of users, identification numbers and access rights can be downloaded into the control unit through the memory access port. In one embodiment of the disclosure, the memory access port is a USB port, although other types of data transfer ports are contemplated as being within the scope of the present disclosure.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a perspective view of a security cabinet having a series of storage lockers and a control panel;

FIG. 2 is a front view of one embodiment of the control panel;

FIG. 3 is a schematic illustration of the control interconnections between a control unit and the various operating components of the security cabinet;

FIG. 4 is an electrical schematic illustration of the operating connections between the door lock actuators of each of the individual storage lockers and a control board;

FIG. 5 is a schematic illustration of the interconnections between the control board and the operating devices of each storage locker;

FIG. 6 is an electrical schematic illustration of the interconnections between both a front and rear control panel for the security cabinet of the present disclosure;

FIG. 7 is a screen shot of the identification information and PIN number for each of a series of individuals that are granted access to the storage lockers; and

FIG. 8 is an audit log indicating the type of access, time of access, and individual users that accessed each of the storage lockers.

### DETAILED DESCRIPTION OF THE INVENTION

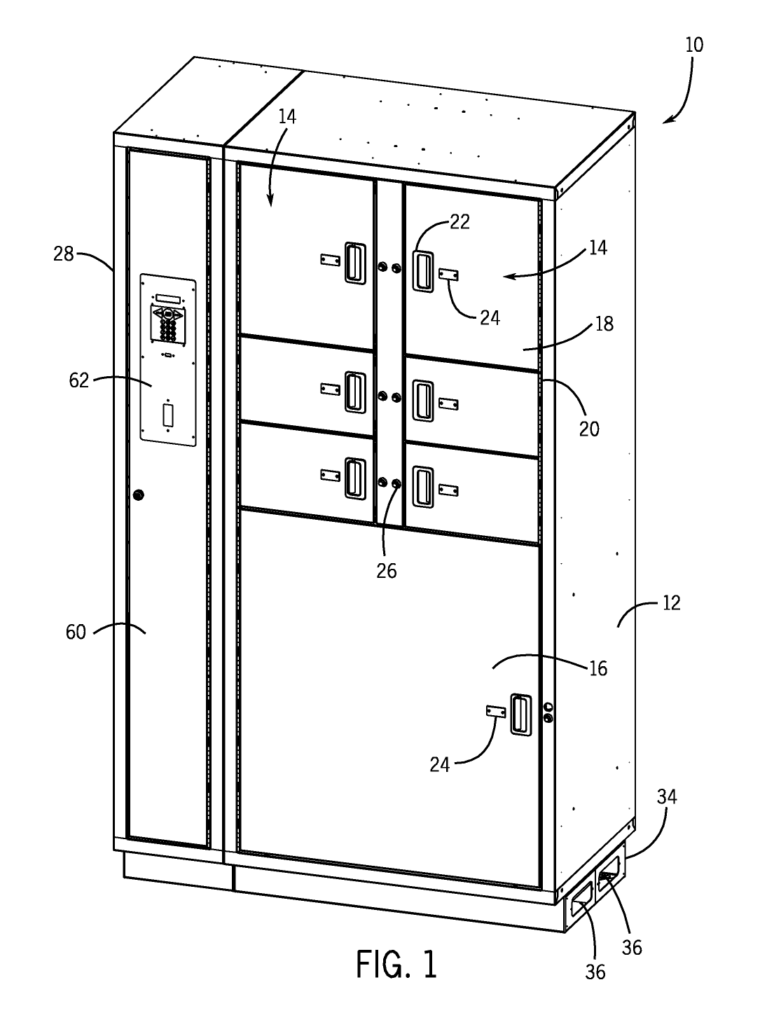

FIG. 1 illustrates one embodiment of a security cabinet 10 constructed in accordance with the present disclosure. The security cabinet 10 shown in FIG. 1 includes an outer cabinet housing 12 that is formed from a durable metallic material. The outer cabinet housing 12 defines a series of individual storage lockers 14. In the embodiment shown in FIG. 1, the outer cabinet housing 12 is sized to define six individual storage lockers 14 as well as a refrigerated compartment 16. Although a refrigerated compartment 16 is shown in the embodiment of FIG. 1, it should be understood that the configuration of the cabinet housing 12 could vary depending upon the specific number and size of the storage lockers needed for the particular facility in which the security cabinet 10 is placed. Additionally, the refrigerated compartment 16 could be replaced by an additional number of individual storage lockers 14.

Each of the individual storage lockers 14 includes an access door 18 that is securely mounted to the outer cabinet housing 12 by a hinge 20. The hinge 20 is a specially designed hinge that prevents tampering to gain unauthorized access to the internal compartment defined by the storage locker 14.

Each access door 18 includes a handle 22 and an identification badge 24. The identification badge 24 typically includes a numeric indicator that identifies each of the individual storage lockers 14. An indicator LED 26 is positioned adjacent to each of the individual storage lockers 14 such that a control unit associated with the security cabinet 10 can communicate to a user the status of the individual lockers in a manner to be defined below.

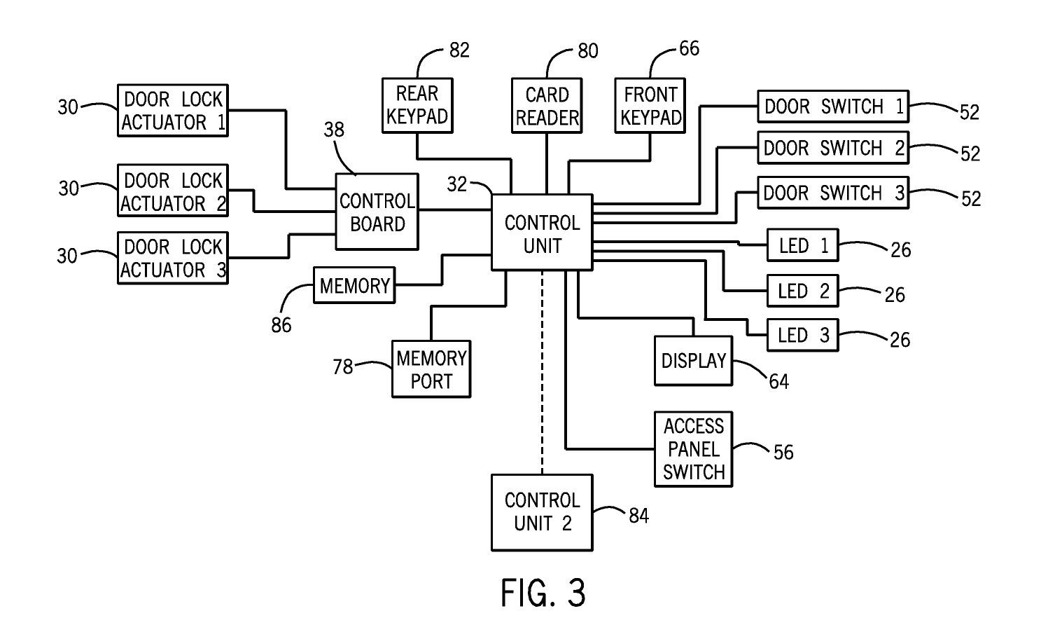

In the embodiment shown in FIG. 1, a control housing 28 is positioned adjacent to the cabinet housing 12. The control housing 28 includes the operating components necessary to control and monitor the access to each of the individual storage lockers 14 and the refrigerated compartment 16. The control housing 28 is positioned adjacent to the security cabinet 10 such that the electrical wires utilized by the control unit contained within the control housing 28 can operate a door locking actuator 30 associated with each of the individual storage lockers 14, as shown in the embodiment of FIG. 3. As illustrated in FIG. 3, each of the individual lockers includes its own independently operable door locking actuator 30. The door locking actuator 30 can be operated by the control unit 32 such that the control unit 32 can selectively permit access and deny access to each of the individual storage lockers 14 through operation of the door lock actuator 30. In the schematic illustration of FIG. 3, the control unit 32 is shown controlling the operation of three separate door lock actuators 30. However, it should be understood that the control unit could control many more door lock actuators 30 while operating within the scope of the present disclosure. The three individual door lock actuators 30 shown in FIG. 3 are shown for illustrative purposes only and are not meant to be a limit on the number of actuators that can be controlled by the control unit 32.

As also illustrated in FIG. 3, the control unit 32 is operatively coupled to each of the individual indicator LEDs 26. Once again, the control unit 32 in FIG. 3 is shown coupled to three LEDs 26, although it is contemplated that the control unit 32 could control as many LEDs as individual storage lockers formed in the security cabinet 10.

Referring back to FIG. 1, the cabinet housing 12 and the control housing 28 are each mounted to a wiring housing 34. As illustrated in FIG. 1, the wiring housing 34 includes a pair of wire ways 36 that each provide a passageway for wiring to pass between the control unit contained within the control housing 28 and the various operating devices contained within the security cabinet 10. In the embodiment of FIG. 1, a single cabinet housing 12 is positioned adjacent to the control housing 28. However, it is contemplated that multiple cabinet housings 12 could be positioned adjacent to each other to expand the number of storage lockers 14 that form part of the security cabinet. The wire ways 36 formed within the wire housing 34 allow multiple outer cabinet housings 12 to be ganged to each other and the single individual control unit 32 control and monitor access to each of the individual storage lockers 14.

In addition to providing an electrical pathway for communication between the control unit of the control housing 28, the wiring housing 34 also provides a passageway for wires containing the required electrical power for operating the various components contained within each of the storage lockers 14, such as the door lock actuator or the refrigeration device included within the refrigerated compartment 16.

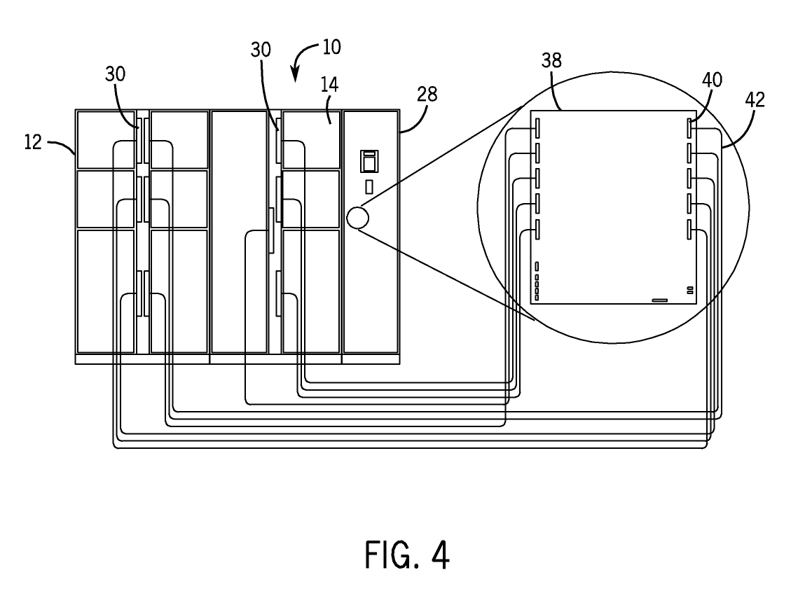

Referring now to FIG. 4, the control unit contained within the control housing 28 is coupled to a control board 38 having a series of individual jumpers 40. Each of the individual jumpers 40 are connected to one of the door lock actuators 30 formed within the outer cabinet housing 12. The individual jumpers 40 provide a point of connection for a control wire 42 to pass from the control board 38 to the individual door locking actuator 30. Referring back to FIG. 3, the control board 38 is coupled to the control unit 32 such that the control unit 32 can control the actuation of each of the individual actuators 30 through the control board 38. Although a single control board 38 is shown in FIG. 3, the control unit 32 could provide control signals to multiple control boards 38 while operating within the scope of the present disclosure.

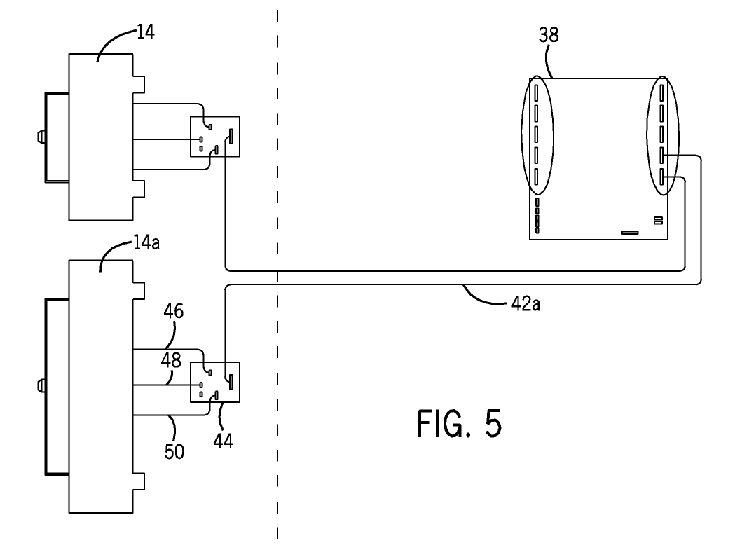

Referring now to FIG. 5, thereshown is additional details of the connection between one of the control boards 38 and the operating components of a pair of individual storage lockers 14. In the embodiment illustrated in FIG. 1, the first locker is in operative communication with the control board 38 through control wire 42a. The first locker 14a includes a jumper board 44 that provides individual interconnections between the single control wire 42a and a door switch wire 46, the LED wire 48 and the door actuator wire 50. As can be understood in FIG. 5, the single control wire 42a coming from the control board 38 is thus able to control the actuation of a door switch, the LED and the door actuator as well as receive signals from the door switch.

Referring back to FIG. 3, each of the individual storage lockers includes a door switch 52 that allows the control unit 32 to determine the status of each individual door of the plurality of lockers. In this manner, the control unit 32 can determine whether each individual door has been opened or closed, which will be vital to the audit function of the control unit 32, as will be described in greater detail below.

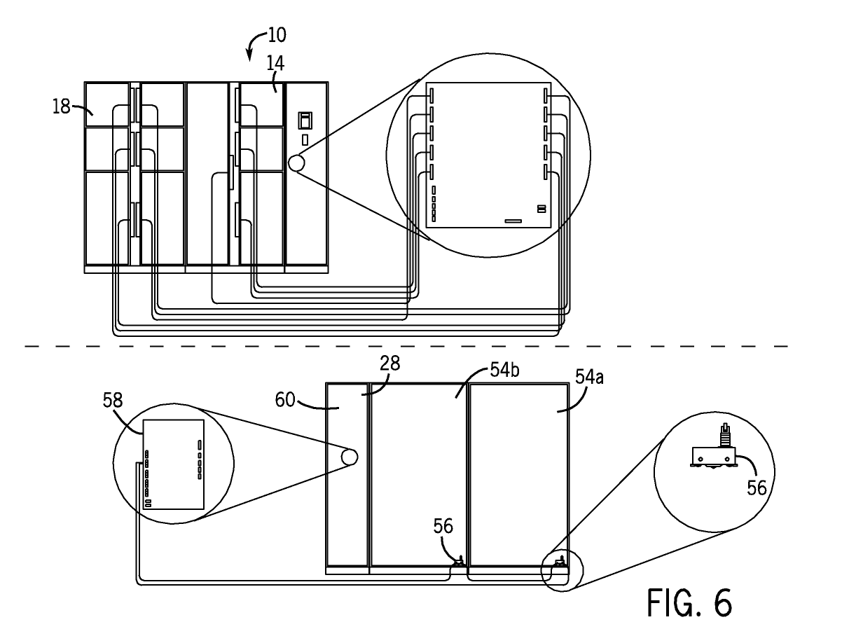

Referring now to FIG. 6, thereshown is an alternate embodiment for the security cabinet of the present disclosure. In the embodiment of FIG. 6, the individual security cabinet 10 is accessible from both the front and the rear such that items can be placed in and removed from each of the individual storage lockers 14 through both the front access door 18 and one or more rear access doors 54. In the embodiment shown in FIG. 6, individual lockers 1-6 can be accessed from the front through individual access doors 18 or from the rear by the single rear access door 54. Likewise, the individual lockers 7-10 can be accessed from the rear through a second rear access door 54b shown in FIG. 6. As illustrated in FIG. 6, each of the access doors 54a and 54b includes a rear door switch 56. The pair of rear door switches 56 communicate to the control unit through a rear control board 58. The rear control board 58 is shown mounted to a rear surface of the control housing 28.

Although one specific embodiment for the rear of the outer cabinet housing 12 is shown in FIG. 6, it should be understood that the two individual rear access doors 54a and 54b could be replaced by individual rear access doors for each of the individual storage lockers. Alternatively, the pair of rear access doors 54a and 54b could be replaced by a single door that provides access to all of the individual lockers 14 simultaneously. Various different configurations for the rear of the security cabinet 10 of the present disclosure are contemplated in accordance with the present disclosure. In each case, however, individual door switches are utilized such that the control unit 32 shown in FIG. 3 is able to determine whether the individual rear access doors 54a or 54b have been opened and whether the items placed within the individual lockers 14 have been accessed. Each of the rear access doors 54a and 54b also includes a door lock actuator such that the control unit is able to selectively permit access to each of the individual storage lockers through the rear access door.

Referring back to FIG. 1, the front face 60 of the control housing 28 includes a control panel 62. The control panel 62 provides a place for a user to interface with the control unit and gain access to each of the individual storage lockers 14.

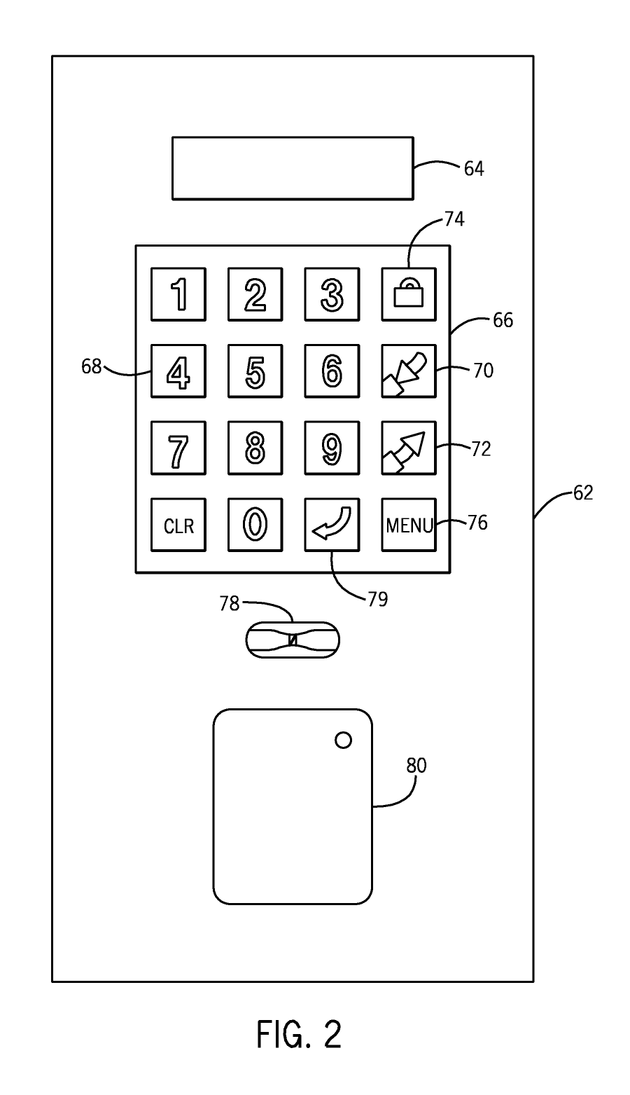

Referring now to FIG. 2, thereshown are the details of the control panel 62 constructed in accordance with one embodiment of the disclosure. In the embodiment shown in FIG. 2, the control panel includes an LCD display screen 64 and a 16-button keypad 66. Although an LCD display screen 64 and a 16-button keypad 66 are shown and described, it should be understood that each of these components could be replaced by alternate equipment. As an example, the display screen 64 and keypad 66 could be integrated together and replaced by a single touch screen or other equivalent data input device. In the embodiment shown in FIG. 2, the keypad 66 includes a series of numeric keys 68 as well as several predefined function keys. In the embodiment shown, the keypad includes a deposit key 70, a removal key 72, a lock key 74 and a menu key 76. Although these specific function keys are shown in the embodiment of FIG. 2, it should be understood that these specific keys could be reconfigured as desired by a particular implementation of the control panel 62.

In addition to the keypad 66 and display screen 64, the control panel 62 also includes a memory access port 78. The memory access port 78 is coupled to the control unit 32, as shown in FIG. 3, such that a user can access data stored within the control unit 32 through the memory access port 78. In addition to accessing data from the control unit 32, the memory port 78 provides a means to upload information to the control unit 32. The information uploaded to the control unit 32 could be revised operating instructions, the access rights of each user as well as any other information needed by the control unit 32 to operate properly. In the embodiment shown in FIG. 3, the memory access port 78 is a USB port. However, it is contemplated that the memory access port 78 could be reconfigured as various different types of conventional data transfer ports, such as a serial input port or an RS-232 port. In the embodiment illustrated, the memory access port 78 is a USB port which is a conventional and well adopted data transfer port at the time of the present disclosure.

The control panel 62 further includes an ID card reader 80. The card reader 80 can be one of various different types of card readers while operating within the scope of the present disclosure. The purpose of the card reader 80 is to read an ID card of a potential user and identify the potential user and provide identification information to the control unit 32. In one embodiment of the disclosure, the card reader 80 is an RFID card reader that allows a user having an identification card to swipe the card over the card reader 80. The card reader 80 reads personal identification information related to the cardholder and provides this information to the control unit 32. Alternatively, the card reader 80 could be a magnetic reader that requires the user to swipe a magnetic identification portion of an identification card through the card reader 80. It is further contemplated that the card reader 80 could be replaced by a bar code reader or any other type of device that is able to read an identification card and provide user identification information to the control unit 32 such that the control unit 32 can quickly and easily identify the identity of the cardholder.

As further illustrated in FIG. 3, the control unit 32 is also connected to a rear keypad 82 that is positioned somewhere on the rear surface of the security cabinet to allow a user to access the rear side of each of the individual storage lockers 14. The rear keypad 82 can take a similar shape to the front keypad 66 shown in FIG. 2. The rear surface of the security cabinet also includes a card reader similar to the card reader on the front of the security cabinet. Additionally, it is contemplated that the rear face of the security cabinet could also include a memory port.

Referring back to FIG. 3, the control unit 32 of the security cabinet 10 can be connected to a second control unit 84 of another security cabinet that is either positioned adjacent to the first security cabinet or positioned some distance from the first security cabinet. The communication between the two control units 32, 84 is contemplated as being RS-485 to allow for fast and efficient communication of information between the two control units 32 and 84. It is also contemplated that the communication between the two control units 32, 84 could be wireless while operating within the scope of the present disclosure.

Referring back to FIG. 2, although the memory port 78 is shown and described as being useful to retrieve information from the control unit 32, it is also contemplated that the memory port 78 provides a convenient programming port for modifying and downloading the operational software used by the control unit 32. The memory port 78 allows an administrator with password access to add, delete and modify the identity of users that can access each of the individual lockers and to change the privileges of each of the users to each of the lockers of the security cabinet. The memory port 78 allows an administrator to change the software stored within the control unit 32 by various different programming procedures, such as utilizing a USB flash drive contained within the control unit 32.

During operation of the control unit 32, the control unit generally controls the access to each of the individual storage lockers through the individual door lock actuators 30. When an individual door is opened or closed, the control unit 32 records the status of the door by monitoring the operation of each of the individual door switches 52. The control unit identifies the person accessing each of the individual lockers through either the card reader 80 or the front keypad 66. The front keypad 66 allows a user to enter a unique identification number such that the control unit 32 determines what type of access the user has to each of the individual storage lockers.

The control unit is able to allow users to log into the system in at least three different ways. In one embodiment, the user can log into the system by utilizing only an ID card. In such a configuration, the user needs to only swipe an ID card past the card reader to access the system. In a second configuration, the user can enter a PIN through the keypad 66 and depress the enter key 79. Finally, in the most secure method of access, the user must both swipe an ID card and subsequently enter a unique PIN into the keypad 66. In yet another contemplated scenario, the control unit may be configured to require more than one user to login in before access is provided to one or more of the security lockers. Various different login scenarios are contemplated by the present disclosure depending upon the requirements of the location of the security cabinet.

Once a user has logged into the system, the control unit 32 is able to store the user identification information, the time of access and the identity of the locker accessed in a memory device 86. The size of the memory device 86 can vary, but it is contemplated that the control unit 32 will be able to store at least 5,000 audit entries within the memory. The size of the memory 86 can be increased to increase the number of audit entries that can be stored before the memory needs to be downloaded and cleared.

As described above, the user can enter identification information through the card reader or keypad 66. It is contemplated that the identification information can be a unique number having three to nine digits. In the contemplated embodiment, at least 4,000 unique identification numbers can be assigned to individuals who may require access to the individual storage lockers. Part of the identification information can include additional digits to define the level of access of the individual to the individual storage lockers. When an individual user accesses one of the lockers, the audit trail entry information includes the user identification number, the time of access, the date of access, the command entered into the control unit, such as access or removal, any alarms that are generated, the lock and unlock signal sent by the control unit to the door lock actuator as well as whether the door was actually opened or closed based upon the status of the individual door switch 52 for the locker.

The memory port 78 shown in FIG. 3 allows an administrator or any other interested personnel to download the audit trail stored within the control unit 32 by simply placing a USB device within the memory port 78. In this manner, the interested personnel can download the specific audit trail to determine the identity of any users that accessed each of the individual storage locker and when the storage locker was accessed. This type of audit trail is particularly desirable when the storage lockers are used to store valuable commodities or to develop a chain of custody for evidence in a law enforcement environment. The ease of access to the audit trail through the memory port 78 allows a user to either download the information for viewing on a separate computer or directly connect to the control unit 32 for retrieving the information stored within the control unit 32.

### Modes of Operation

The control unit 32 is able to operate in various different modes of operation depending upon the requirements of the user and the contents of each individual storage locker. Although various different modes of operation are set forth below, it should be understood that other types of modes of operation are certainly contemplated while being within the scope of the present disclosure

Non-Pass Through Mode

In this mode of operation, all access to each of the storage lockers is monitored and recorded by the control unit. In the non-pass through mode of operation, individual users are assigned rights based upon whether the user is able to either deposit, remove, or both remove and deposit items from within the individual storage lockers. The user is able to select which locker to deposit items based upon user need and availability.

Initially, the user logs into the system by either entering a personal identification number (PIN) through the keypad 66 or by swiping an identification card past the card reader 80. Once the user identification information has been entered by the user and validated by the control unit 32, the control unit 32 determines what type of rights are assigned for that user. If the user has deposit rights, the control unit illuminates the LED of all the lockers that are currently empty. The user is prompted to select which locker the user would like to deposit articles. The user selects and enters the locker number based upon the printed locker identification badge 24 shown on the front door of each individual locker, as shown in FIG. 4.

Once the user enters the locker identification information, the control unit 32 turns the LED indicator 26 green and unlocks the locker door through the door lock actuator. Once the door is unlocked, the control unit 32 blinks the LED indicator to visually indicate that the locker door is unlocked and then monitors whether the locker door is opened through the door switch associated with the individual locker. Once the door switch indicates the locker door is opened, the control unit 32 then monitors for whether the locker door is closed, again through the door switch assigned to the locker.

Once the locker has been loaded with the article, the user depresses the lock key 74 on the control panel 62. Alternatively, if the lock key 74 is not depressed, the control unit will automatically lock the door after a timeout period. Once the control unit determines that the door has been unlocked, opened and subsequently closed, the control unit 32 marks the locker “full” and stores the associated audit trail within the memory 86.

If a user or evidence tech enters his or her identification information through either the front keypad 66 or the card reader 80 and has the proper removal rights, the control unit 32 determines which lockers are full and turns the associated LED indicators 26 green, indicating that the user can remove items from the individual locker. The user enters the desired locker number and the control unit unlocks the door and monitors for whether the door is opened and subsequently closed by the user through the individual door switch for the locker. If the control unit determines that the door has been opened and subsequently “closed”, the control unit marks the locker empty and records the associated audit trail within the memory 86.

Passback Mode

In the passback mode, an evidence tech can load a locker with evidence and then assign the locker to an officer. The officer is able to remove and deposit the evidence as required. Once the officer has finished with the evidence, the evidence tech removes the evidence, which also unassigns the particular officer from the locker. In this mode, the audit log or trail documents all access to the locker.

Initially, an evidence tech logs in at the keypad of the control panel and depresses the deposit key 70, as shown in FIG. 2. Once the evidence tech has logged in and selects the deposit function, the evidence tech enters the number of the locker and deposits the evidence in the locker. Once the evidence has been deposited, the evidence tech disables door access at the keypad by depressing the menu key 76 and the lock key 74. Once in this condition, the evidence tech downloads the current door configuration to the flash drive and inserts the flash drive into a PC.

Once the information is available on the PC, a desired officer is assigned to the locker and the information is stored onto the flash drive. The flash drive is then inserted into the memory access port 78 on the control panel, which uploads the information onto the control unit. Once the information is downloaded into the control unit, the officer is told that evidence is ready for use.

When an officer desires to remove evidence from one of the storage lockers, the officer initially logs in through either his PIN or identification card. Once the officer has logged in, the officer depresses the removal key 72 and all full lockers available to the officer are illuminated. The officer enters the desired door number and the locker door is unlocked. Once the officer opens the door, the control unit tracks this condition as well as closure of the door after the evidence has been removed. Once the officer has removed the evidence, the lock key 74 is depressed and the control unit marks the locker empty, which is stored in the audit log.

After the officer has completed his use of the evidence, the officer logs in at the touch pad and depresses the deposit key 70. All the empty lockers available to the officer are identified by the illuminated LED indicators. The officer enters the desired door number, which causes the control unit to unlock the identified locker. Once the officer opens the door, deposits the evidence and shuts the door, the officer depresses the lock key 74 which causes the control unit to lock the door and indicate that the locker is full.

During the process described above, the control unit provides a complete audit trail of the number of times the evidence was removed and replaced by the officer after the evidence tech deposited the evidence within the locker for use by the officer.

In alternate configurations of the security cabinet, the security cabinet may have rear doors through which the evidence tech can load evidence into the individual lockers. The steps described above are repeated for an embodiment that has rear access doors except that the evidence tech can deposit items through both the front and rear doors while the officer is able to access the lockers only through the front doors.

In a security cabinet in which the cabinet includes both front access doors and rear access doors, the control unit carries out similar steps as described above, but additionally monitors for whether the rear access panel is opened or closed. Typically, evidence techs are able to open the rear door panels to either load evidence into individual lockers or to remove evidence deposited into the lockers by other users. In the passback mode of operation, both the evidence tech and users can deposit and remove items from assigned lockers depending on access rights granted to each user. Evidence techs are typically granted full access to each of the storage lockers. As with the mode described above, all access information is fully audited and stored in the memory 86.

Crash Locker Mode

In this mode of operation, a user is able to deposit items into a storage locker for secure storage and retrieval at a later time. In the crash locker mode, an evidence tech does not load or unload items into the storage locker and no manual rear door option is available. The crash locker mode simply allows a user to select a locker and store items for a limited period of time. The control unit 32 prevents others from accessing the locker which allows the user the security that items stored in the locker will not be retrieved by other personnel.

Initially, an officer or user logs into the system at the control panel through either the keypad 66 or the card reader 80. Once the officer has logged in, the officer chooses to deposit items by depressing the deposit key 70. Once the deposit key is depressed, the control unit illuminates the LED associated with each storage locker that is currently empty.

After all of the empty lockers are identified, the officer enters the desired locker number through the keypad 66, which causes the control unit to unlock the specific locker door. Once the door is unlocked, the officer opens the door, deposits the evidence and again shuts the door. Once the door has been shut, the officer depresses the lock key 74 which causes the locker door to become locked. After the door is locked, the control unit marks the specific locker as “full” and assigns the locker to the specific officer.

Once a locker has been assigned to the officer, only the officer that deposited the evidence in the locker can remove evidence from the locker. To remove the evidence, the officer again logs in at the control panel and depresses the removal key 72. After the remove button has been depressed, the LEDs associated with all of the full lockers accessible by the particular officer are illuminated. The officer then enters the desired locker number which causes the control unit to unlock the selected locker. Once unlocked, the officer can open the door, remove the evidence and shut the door. The opening and closing of the door is recognized by the control unit through the individual door switches.

Once the locker has been emptied, the officer depresses the lock key 74 or the auto lock timeout expires and the locker door is once again locked. Once the locker door is locked, the control marks the locker as “empty” and makes it available for future deposits.

Gun Locker Mode

In another contemplate embodiment, the security cabinet can include one or more lockers that are used to store hand guns. In such an embodiment, only a single individual user is able to access the storage locker once an item has been placed in the storage locker. Lockers can be assigned to each individual user such that when a user enters their PIN or swipes their identification card, a single locker assigned to the user is opened. Since the locker is used to store dangerous weapons, only the individual user is allowed to access the assigned locker. In such an embodiment, all access is audited but whether the locker is empty or full may not be tracked.

Pass Through Mode

In this mode, an individual user is able to deposit items through the front door of the security cabinet while items are removed by an evidence tech through a rear access door. Items cannot be removed from the front door and items cannot be placed into the locker from the rear door. In this manner, a user is able to deposit an article, such as a piece of evidence, and only an evidence tech can remove the item through the rear door. In such a mode, all access is fully audited as well as whether the locker is full or empty.

In the pass through mode, an officer initially logs in at the control panel, either through the keypad or the card reader. Once the officer has logged in, the control unit activates the LEDs associated with all available lockers. Once the available lockers are identified, the officer enters the desired locker number through the key pad and the control unit unlocks the door for the selected locker. Once the door is unlocked, the officer opens the door, deposits the evidence and again shuts the door. Once the door is shut, the officer either presses the lock key 74 or the control unit automatically locks the door after a timeout period. Once the locker has been loaded with an item, the control unit marks the locker as “full” and makes the locker available only to users that have “withdrawal” rights, such as an evidence tech.

When an evidence tech or another person having the appropriate withdrawal rights needs to withdraw evidence from the locker, the evidence tech logs in at a rear touchpad and all full lockers are identified through illuminated LEDs. The evidence tech enters the desired door number which causes the control unit to unlock the selected locker. Once unlocked, the door is open and the evidence tech removes the evidence and again shuts the door. Once the door is shut, the evidence tech can depress the lock button at which time the door is locked and the control unit marks the locker as “empty”.

Alarm Modes

The control unit 32 can be programmed to perform many different functions based upon the status of the door switch, the status of the door locks, and the access denied or granted through data entry by the card reader 80 or front keypad 66. As one illustrative example, the control unit 32 can generate an alarm when the state of a door is improper. As an example, if the control unit has not activated the door lock actuator to unlock the door and the control unit determines that the door has opened through the associated door switch, the control unit 32 will generate an alarm indicating forced entry into the storage locker.

As another illustrative example, if the door switch indicates that a door has been opened but the door switch does not indicate the locker door was ever closed, the control unit 32 may activate a reminder alarm to the user that the locker door needs to be closed and subsequently locked.

As a further example, an alarm can be activated if the user unlocks a door and the control unit does not detect that the door was ever opened. This situation indicates that the door lock may be malfunctioning or that the door switch may also be malfunctioning. The alarm can be generated and an error message displayed to the user.

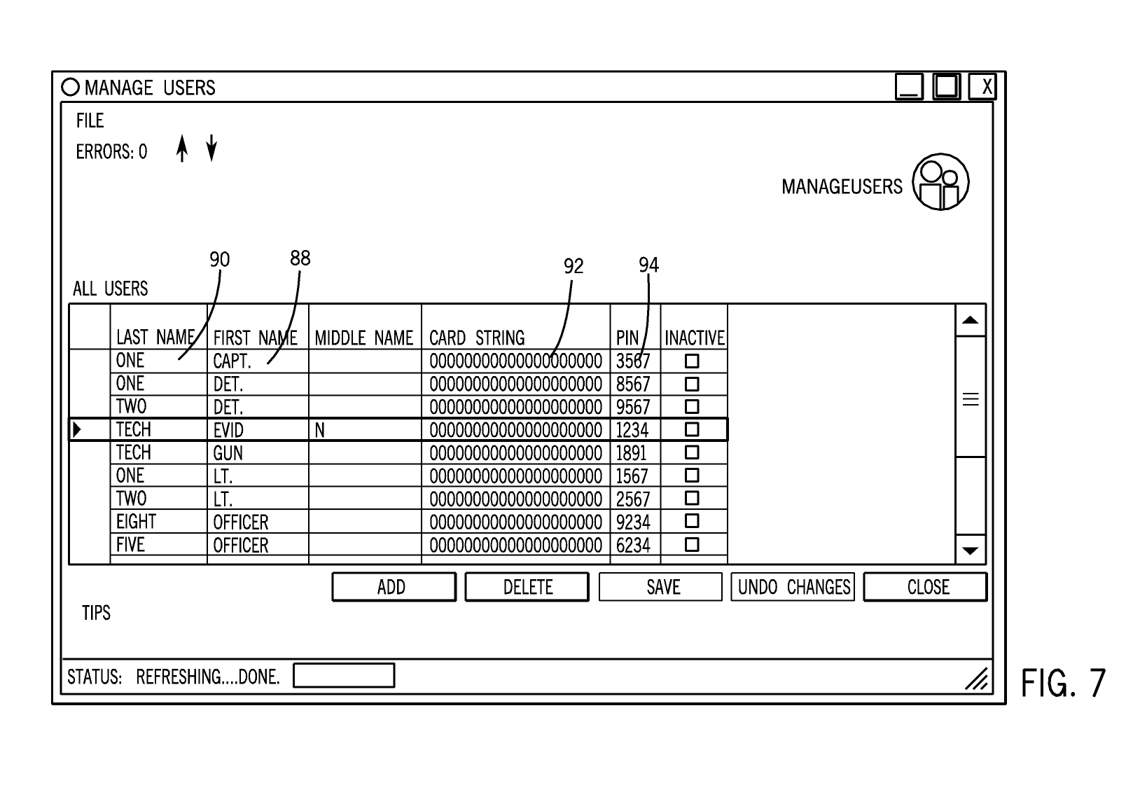

As described above, each officer or evidence tech is assigned a unique PIN or identification number such that when the officer or user approaches the control panel 62, the control panel 62 can identify the particular officer. The screen shot shown in FIG. 7 illustrates one example of the identification information for each of the various individuals that may access the security cabinet. In the management program shown in FIG. 7, each user is identified by a first name 88 and a last name 90. Each individual has an identification code 92 and a PIN number 94 that uniquely identify each of the individuals. The identification number 92 can be stored magnetically on an identification card while the PIN 94 is used by the individual to log into the control unit through the control panel. The number of digits used in the identification number and PIN number can be varied depending upon the level of security needed and the number of users accessing the security cabinet.

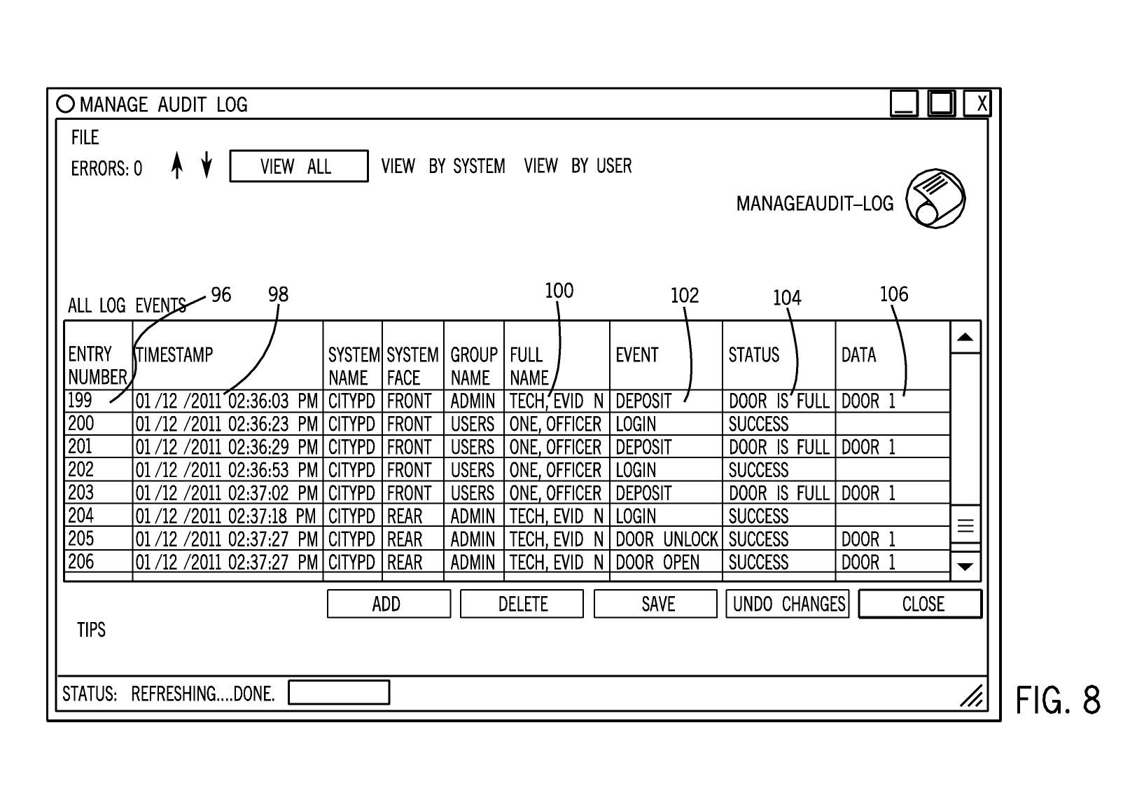

During operation of the control unit in any one of the modes identified above, the control unit creates an audit log or trail each time that a user either deposits material into the locker or removes material from the locker. FIG. 8 illustrates a screen shot of various different activities performed and stored in the audit trail. As an illustrative example, the screen shot of FIG. 8 includes a unique entry number 96 having a time stamp 98. The time stamp indicates the specific time an event took place. The event includes the full name of the user 100 as well as the type of event that took place, as indicated by entry 102. As the entries in column 102 indicate, the events can be a deposit, a login, a door unlock, a withdrawal or other activities that are uniquely monitored by the control unit. As indicated in FIG. 8, the status associated with the event is shown in column 104 while the specific door number is shown in column 106. As described previously, the memory 86 shown in FIG. 3 is capable of storing at least 5,000 individual events.

When the user wishes to review the audit log, the user inserts a flash memory device into the memory port 78 positioned on the control panel 62. Once the memory device is inserted, the audit log is stored onto the memory device. Once the audit log has been downloaded, a message is shown on the display 64 indicating that the memory log has successfully been downloaded. In the contemplated embodiment, the memory log is encrypted such that should the log be lost, there is no security risk due to the encrypted files.

After the audit log has been stored on the flash drive, the audit log can be stored onto a managing PC. Once the information is received and verified on the managing PC, the audit log information can be erased from the control unit. However, it is important that the audit log is deleted from the control unit only after the files have been successfully downloaded to the managing PC.

We claim:

1. A security cabinet comprising:
a plurality of storage lockers each having an internal space and a locker door;
a door lock actuator associated with each of the storage lockers, the door lock actuator being operable to lock the locker door and prevent access to the internal space and unlock the locker door to allow access to the internal space;
a door switch associated with each of the storage lockers, the door switch being operable to indicate both the opening and the closing of the locker door;
a control unit operatively coupled to each of the door lock actuators and each of the door switches, wherein the control unit monitors the opening and closing of each locker door through the door switches and controls the operation of the door lock actuators to lock and unlock the locker doors,
wherein the control unit creates and stores an audit log of at least when the locker doors open and close and when the locker doors are locked and unlocked; and
a memory access port coupled to the control unit to permit downloading of the stored audit log from the control unit.

2. The security cabinet of claim 1 further comprising a user identification device coupled to the control unit such that the control unit can determine the identity of a user through the user identification device.

3. The security cabinet of claim 2 wherein the user identification device is a card reader.

4. The security cabinet of claim 2 wherein the user identification device is a keypad.

5. The security cabinet of claim 2 wherein the audit log includes the identity of the user.

6. The security cabinet of claim 1 wherein the memory access port is a USB port.

7. A method of monitoring and controlling, access to a plurality of storage lockers formed in a security cabinet, the method comprising the steps of:
receiving user identification information from a user in a control unit of the security cabinet;
receiving a locker access request from the user;
determining access rights of the user in the control unit and permitting the locker access request based upon the access rights for the user;
unlocking a user-selected storage locker only when the user has the proper access rights;
monitoring the opening and the closing of the locker door;
creating an audit log entry; and
storing the audit log entry in an audit log stored in memory of the control unit.

8. The method of claim 7 further comprising the step of downloading the audit log to an external storage device through a memory access port.

9. The method of claim 7 wherein the user identification information is received from a card reader or a keypad coupled to the control unit.

10. The method of claim 7 wherein each audit log entry includes at least the user identification information, a time entry, locker identification information and the locker door status.

11. The method of claim 7 further comprising the step of preventing access to a storage locker when the user identification information and the access rights for the user do not match the locker access request.

12. The method of claim 7 further comprising the step of providing a visual indicator to the user of the storage lockers that meet with the locker access request.

13. The method of claim 12 further comprising the step of receiving locker identification information from the user and permitting access to only the locker identified by the locker identification information from the user.

14. The method of claim 7 further comprising the steps of:
assigning an identification number to each user of the security cabinet;
assigning the access rights to each user; and
storing a listing of users, a listing of identification numbers and a listing of access rights in the control unit.

15. The method of claim 14 wherein the list of users, the list of identification numbers and the list of access rights are uploaded into the control unit through a memory access port.

16. The method of claim 15 wherein the audit log is downloadable from the control unit through the memory access port.

17. The method of claim 16 wherein the memory access port is a USB port.

18. A security cabinet comprising:
a plurality of storage lockers each having an internal storage space and a locker door;
a control unit operable to lock and unlock the locker door on each of the plurality of storage lockers;
a user identification device coupled to the control unit to provide the identity of a user to the control unit, wherein the control unit creates an audit log entry in an audit log each time a user accesses one of the storage lockers; and
a memory access port coupled to the control unit to permit downloading of the audit log created and stored by the control unit.

19. The security cabinet of claim 18 wherein the control unit receives user identification information from a user, receives a locker access request from the user and determines the access rights of the user to permit access to the storage locker when the locker access rights of the user correspond to the locker access request from the user.

20. The security cabinet of claim 19 wherein the access rights of the user are uploaded into the control unit through the memory access port and the audit log is downloaded from the control unit through the memory access port.
